(19) United States
(12) Patent Application Publication
(10) Pub. No.: US 2009/0080494 A1
(43) Pub. Date: Mar. 26, 2009

(54) Communication system and communication method

(75) Inventors: Shigemi Kurashima, Shinagawa (JP); Masahiro Yanagi, Shinagawa (JP); Takuya Uchiyama, Shinagawa (JP); Satoshi Sakurai, Shinagawa (JP); Takashi Arita, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 12/000,676

(22) Filed: Dec. 14, 2007

(30) Foreign Application Priority Data
Sep. 21, 2007 (JP) 2007-246035

(51) Int. Cl. H04B 7/155; H04B 1/69

(52) U.S. Cl. 375/130; 455/14; 375/E01.001

(57) ABSTRACT

A communication system is disclosed that includes a first device that performs communication of information with the outside; a second device through which the information is input and output; and a relay device that performs wired communication with the first device and wireless communication with the second device to relay the information between the first device and the second device.

### BACKGROUND OF THE INVENTION

1. Field of the Invention

The present invention relates generally to communication systems and communication methods and, in particular, to a communication system and a communication method for inputting and outputting music, broadcast content, etc., to and from an input/output device.

2. Description of the Related Art

Recently, with the progress of short-range wireless communication technologies such as wireless LAN and Bluetooth, there have been developed communication systems for transmitting information between devices via a wireless communication network.

Such communication systems are of a type that includes a short-range wireless communication unit and a power source, for example, in each of a mobile-phone handset and a headset for mutual exchange of audio signals, thus making it possible to make a phone call without holding the mobile-phone handset (see, for example, Patent Documents 1 through 3).

### Patent Document 1: JP-A-2002-271453

### Patent Document 2: JP-A-2005-318288

### Patent Document 3: JP-A-2006-86746

### SUMMARY OF THE INVENTION

In this conventional communication system, however, the short-range wireless communication unit is incorporated in the mobile-phone handset that is a source for supplying information to the headset. Therefore, if the headset is used to make a phone call through the short-range wireless communication, the mobile-phone handset is required to perform both wireless communication with a mobile phone network and short-range wireless communication with the headset, causing excessive consumption of battery power of the mobile-phone handset. Moreover, the function of such communication systems is limited.

Accordingly, the present invention has been made in view of the above drawbacks and may provide a communication system and a communication method capable of reducing consumption of battery power of each device, realizing long-time use, and providing multiple functions.

The present invention provides a communication system comprising a first device that performs communication of information with the outside; a second device through which the information is input and output; and a relay device that performs wired communication with the first device and wireless communication with the second device to relay the information between the first device and the second device.

According to this configuration, the first device receives a broadcast, and the relay device performs short-range wireless communications with the second device to transmit the broadcast received by the first device to the second device.

The relay device includes driving batteries separate from the first device.

According to this configuration, the first device includes a broadcast reception section that receives a broadcast, a processing section that processes a signal received by the broadcast reception section, and a first interface section that transmits the signal processed by the processing section to the relay device.

According to this configuration, the relay device is capable of constituting a wireless communication network.

According to this configuration, the first device and the relay device are directly connected to each other through a connector.

According to this configuration, at least the relay device and the second device perform wireless communications through ultra-wide band wireless communication.

According to this configuration, at least the relay device and the second device have ultra-wide band antennas.

According to this configuration, at least the relay device and the second device measure a position and a distance with a position and distance measuring function of ultra-wide band wireless communication and form a network based on results of measuring the position and the distance.

According to this configuration, the first device receives information transmitted from a device present in a specific area and transmits the information to the second device via the relay device.

According to the embodiments of the present invention, communication of information is performed with the first device that performs communication of information with the outside; the second device through which the information is input and output; and the relay device that performs wired communication with the first device and wireless communication with the second device to relay information between the first device and the second device. Since wireless communications are performed between the relay device and the second device, the first device is not required to have a function of performing wireless communications with the second device, thus making it possible to reduce power consumption for performing wireless communications with the second device and to reduce power consumption of the first device. Furthermore, it is also possible to change the first device to be connected to the relay device.

### BRIEF DESCRIPTION OF THE DRAWINGS

FIG. 1 shows a schematic view of a first embodiment of the present invention;

FIG. 2 shows a block diagram of the first embodiment of the present invention;

FIG. 3 shows a block diagram of the tuner unit 111;

FIG. 4 shows a block diagram of the transmission/reception unit 112;

FIG. 5 shows a block diagram of a transmission/reception circuit section 134;

FIG. 6 shows a block diagram of an input/output unit 113;

FIG. 7 shows a schematic view of a second embodiment of the present invention;

FIG. 8 shows a block diagram of the second embodiment of the present invention;

FIG. 9 shows a schematic view of a modified embodiment of the second embodiment of the present invention; and

FIG. 10 shows an operational explanatory view of an example to which the embodiments of the present invention are applied.

### DETAILED DESCRIPTION OF THE PREFERRED EMBODIMENT

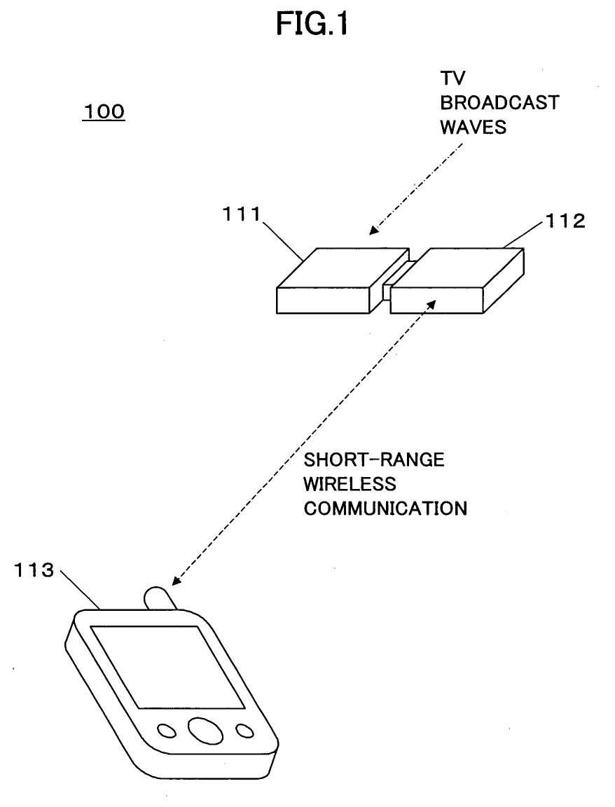

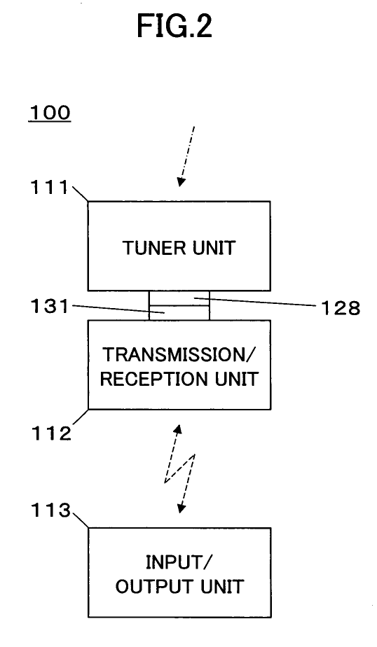

FIG. 1 shows a schematic view of a first embodiment of the present invention and FIG. 2 shows a block diagram thereof.

A communication system 100 of this embodiment includes at least a tuner unit 111, a transmission/reception unit 112, and an input/output unit 113.

The tuner unit 111 is equivalent to a first device, receives a television broadcast, etc., and supplies it to the transmission/reception unit 112.

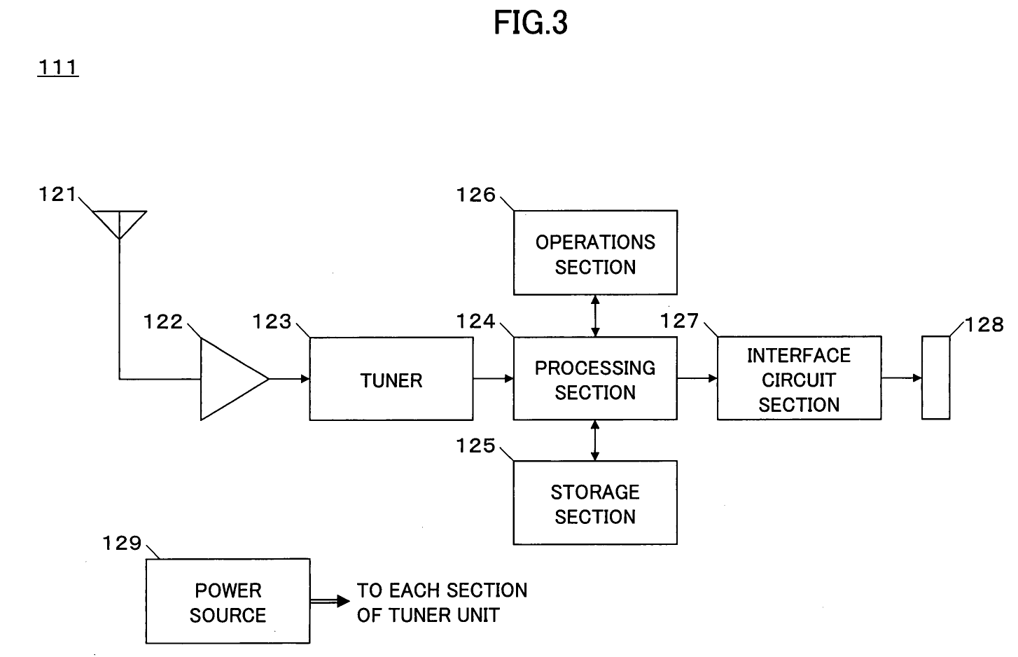

FIG. 3 shows a block diagram of the tuner unit 111.

The tuner unit 111 is the first device and includes at least an antenna 121, an amplifier 122, a tuner 123, a processing section 124, a storage section 125, an operations section 126, an interface circuit section 127, a connector 128, and a power source 129.

The antenna 121 converts a television broadcast signal into an electric signal. The electric signal converted by the antenna 121 is supplied to the amplifier 122. The amplifier 122 amplifies the electric signal supplied from the antenna 121 and supplies it to the tuner 123.

The tuner 123 selects the broadcast signal of the broadcast station selected by the operation of the operations section 126 from the electric signal supplied from the amplifier 122. Note that the broadcast signal includes video and audio information. The broadcast signal selected by the tuner 123 is supplied to the processing section 124.

The processing section 124 performs processing so as to transmit the broadcast signal supplied from the tuner 123 to the input/output unit 113. The storage section 125 is composed, for example, of a semiconductor memory and used as a storage area for the processing section 124.

The operations section 126 is connected to the processing section 124 and operated by the user, for example, to select a channel.

The interface circuit section 127 provides an interface between the processing section 124 and the transmission/reception unit 112. The connector 128 is connected to the transmission/reception unit 112 through cables or couplers. The power source 129 is composed, for example, of batteries and supplies driving power to the tuner unit 111.

The broadcast signal received by the tuner unit 111 is supplied to the transmission/reception unit 112 from the interface circuit section 127 via the connector 128.

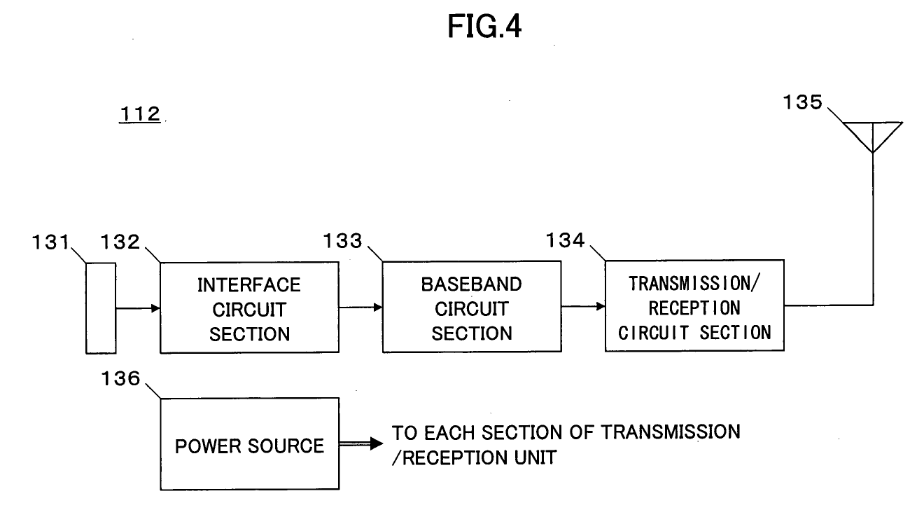

FIG. 4 shows a block diagram of the transmission/reception unit 112.

The transmission/reception unit 112 is connected to the connector 128 of the tuner unit 111 through cables or couplers and wirelessly transmits the signal supplied from the tuner unit 111 to the input/output unit 113. Moreover, the transmission/reception unit 112 receives the operational information from the input/output unit 113 and supplies it to the tuner unit 111.

The transmission/reception unit 112 is a relay device and includes at least a connector 131, an interface circuit section 132, a baseband circuit section 133, a transmission/reception circuit section 134, an antenna 135, and a power source 136.

The connector 131 is connected to the connector 128 of the tuner unit 111 directly or through cables. The signal supplied from the connector 128 of the tuner unit 111 to the connector 131 is supplied to the interface circuit section 132.

The interface circuit section 132 provides an interface between the interface circuit section 127 and the baseband circuit section 133. The baseband circuit section 133 performs processing of a baseband signal.

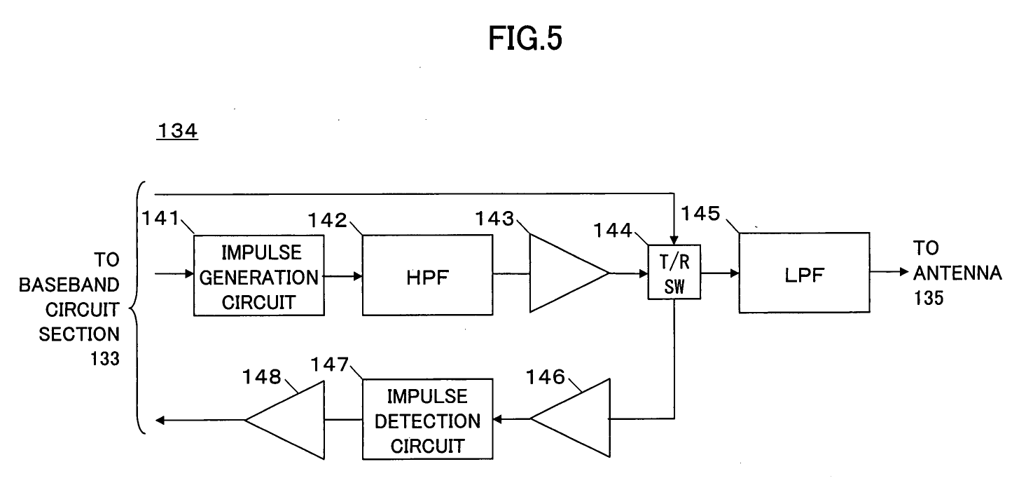

FIG. 5 shows a block diagram of the transmission/reception circuit section 134.

The transmission/reception circuit section 134 transmits/receives a signal with the UWB (ultra-wide band) impulse system. The transmission/reception circuit section 134 generates an impulse based on the signal processed by the baseband circuit section 133 and supplies it to the antenna 135. Further, the transmission/reception circuit section 134 detects an impulse from the signal received by the antenna 135 and supplies it to the baseband circuit section 133 as a baseband signal. The transmission/reception circuit section 134 includes at least an impulse generation circuit 141, a high-pass filter 142, a power amplifier 143, a transmission/reception change-over switch 144, a low-pass filter 145, a low noise amplifier 146, an impulse detection circuit 147, and an amplifier 148.

The impulse generation circuit 141 generates an impulse based on the transmission signal supplied from the baseband circuit section 133. The impulse generated by the impulse generation circuit 141 corresponds to the transmission signal supplied from the baseband circuit section 133.

The high-pass filter 142 allows high frequency components including the frequency component of the impulse generated by the impulse generation circuit 141 to pass through and eliminates low-frequency noise components. Accordingly, it is possible to eliminate the noise whose frequency is lower than that of the impulse.

The impulse from the high-pass filter 142 is supplied to the power amplifier 143. The power amplifier 143 outputs the impulse from the high-pass filter 142 after amplifying its power. The impulse whose power is amplified by the power amplifier 143 is supplied to the transmission/reception change-over switch 144.

The transmission/reception change-over switch 144 switches the connection of the low-pass filter 145 to either the power amplifier 143 or the low noise amplifier 146 in accordance with the transmission/reception change-over control signal from the baseband circuit section 133. The transmission/reception change-over switch 144 switches the connection of the low-pass filter 145 to the power amplifier 143 for transmission and switches the connection of the low-pass filter 145 to the low noise amplifier 146 for reception.

The low-pass filter 145 allows low frequency components including the frequency component of the impulse supplied from the power amplifier 143 to pass through for transmission and eliminates high frequency noise components. The impulse passing through the low-pass filter 145 is supplied to the antenna 135 and emitted.

Moreover, the low-pass filter 145 allows low frequency components including the frequency component of the impulse out of the signal received by the antenna 135 to pass through at reception and eliminates high frequency noise components. The signal passing through the low-pass filter 145 is supplied to the low noise amplifier 146 through the transmission/reception change-over switch 144.

The low noise amplifier 146 amplifies the signal supplied from the low-pass filter 145 through the transmission/reception change-over switch 144 and supplies it to the impulse detection circuit 147.

The impulse detection circuit 147 detects an impulse from the signal supplied from the low noise amplifier 146 and supplies it to the amplifier 148. The amplifier 148 amplifies the impulse supplied from the impulse detection circuit 147 and supplies it to the baseband circuit section 133 as a baseband signal.

With the UWB impulse system as described above, the antenna 135 is composed, for example, of a UWB (ultra-wide band) antenna, a wide band antenna, or a directional antenna. The antenna 135 emits an electric wave, corresponding to the signal supplied from the transmission/reception circuit section 134, in the air and supplies an electric wave from the input/output unit 113 to the transmission/reception circuit section 134 after converting it into an electric signal.

The power source 136 is composed, for example, of batteries. The power source 136 is incorporated in the transmission/reception unit 112 and supplies driving power to the transmission/reception unit 112. Accordingly, the transmission/reception unit 112 does not require the provision of driving power from the tuner unit 111, thus making it possible to reduce consumption of power from the power source 129 of the tuner unit 111. Moreover, it is not required to transmit power through the connectors 128 and 131, thus making it possible to reduce the number of pins of the connectors 128 and 131.

The transmission/reception unit 112 transmits the broadcast signal supplied from the tuner unit 111 with predetermined short-range wireless communication methods such as wireless LAN, Bluetooth, and UWB. Moreover, the transmission/reception unit 112 receives the operational information wirelessly transmitted from the input/output unit 113 with the predetermined short-range wireless communication methods such as wireless LAN, Bluetooth, and UWB.

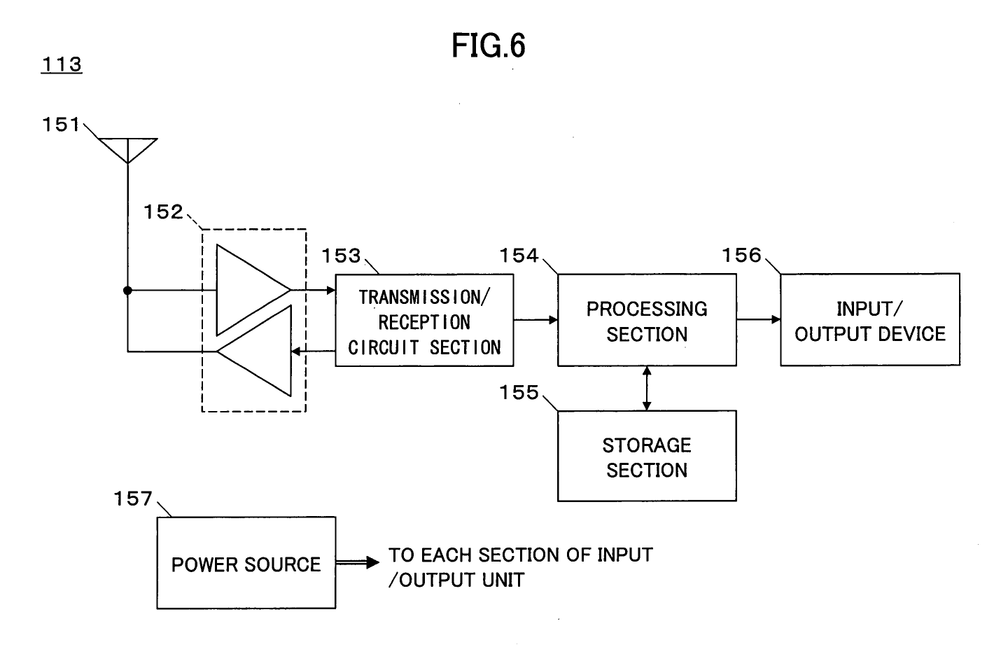

FIG. 6 shows a block diagram of the input/output unit 113.

The input/output unit 113 is a second device and includes at least an antenna 151, an amplifier 152, a transmission/reception circuit 153, a processing section 154, a storage section 155, an input/output device 156, and a power source 157.

The antenna 151 is composed, for example, of a wide band antenna or a directional antenna. The antenna 151 emits the signal supplied from the amplifier 152 as an electric wave in the air and supplies an electric wave from the transmission/reception unit 112 to the amplifier 152 after converting it into an electric signal.

The transmission/reception circuit section 153 demodulates a broadcast signal from the electric signal supplied from the antenna 151 and supplies it to the processing section 154. Moreover, the transmission/reception circuit section 153 transmits from the antenna 151 an electric wave corresponding to the operational information supplied from the input/output device 156.

The processing section 154 converts the broadcast signal supplied from the transmission/reception circuit section 153 so as to be driven by the input/output device 156 and supplies it to the input/output device 156. The storage section 155 is composed, for example, of a semiconductor memory and used as a working storage area for the processing section 154.

The input/output device 156 is composed, for example, of a LCD, a speaker, and an operating switch. The input/output device 156 is driven based on the broadcast signal from the processing section 154 and displays video and outputs audio. Furthermore, the input/output device 156 supplies a signal corresponding to the operation by the operating switch to the processing section 154. The power source 157 is composed, for example, of batteries and supplies driving power to the input/output unit 113.

In this embodiment, the video and audio of the broadcast selected by the tuner unit 111 are supplied to the transmission/reception unit 112 with the interface of a predetermined wired method and wirelessly transmitted to the input/output unit 113 from the transmission/reception unit 112 as described above. As a result, the video is output from the monitor of the input/output unit 113 and the audio is output from the speaker. According to this embodiment, the tuner unit 111 and the input/output unit 113 are independently provided. Therefore, it is possible to arrange the tuner unit 111 at a position suitable for receiving the broadcast and the input/output unit 113 at a position suitable for viewing the same, thus realizing a reliable and comfortable viewing of and listening to the broadcast.

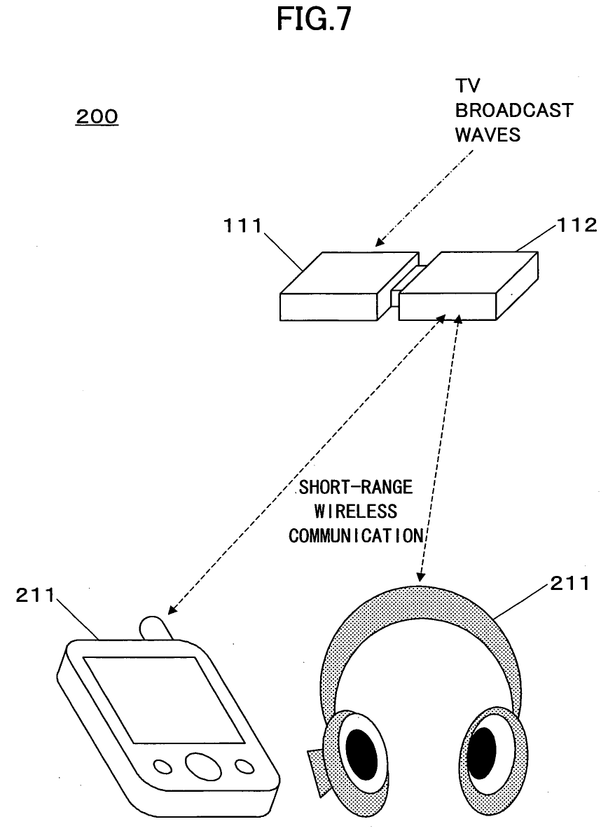

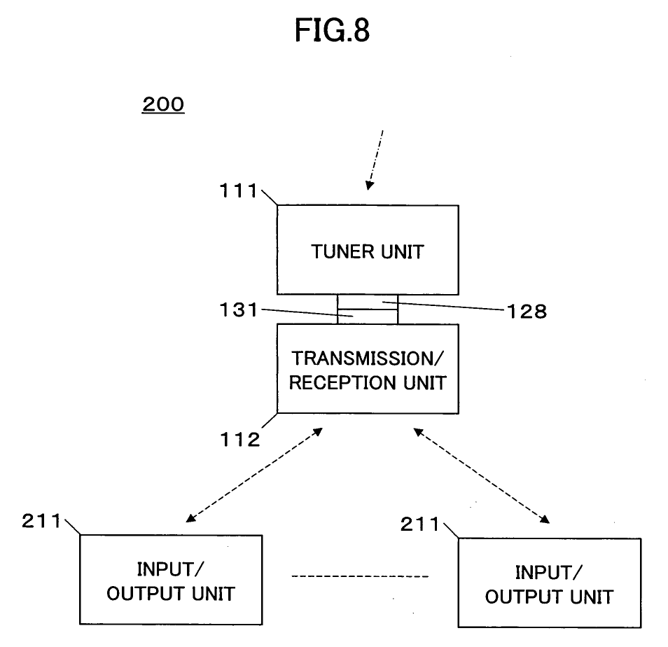

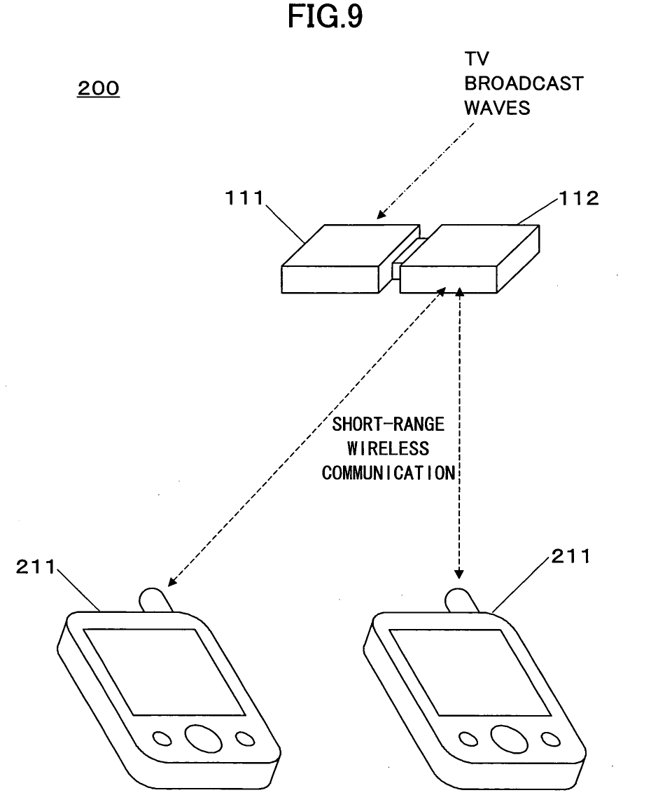

FIG. 7 shows a schematic view of a second embodiment of the present invention, FIG. 8 shows a block diagram thereof, and FIG. 9 shows a schematic view of a modified embodiment of the second embodiment of the present invention. In FIGS. 7 through 9, the components the same as those of FIGS. 1 and 2 are indicated by the same reference numerals, and the description thereof is accordingly omitted.

A communication system 200 of this embodiment is configured in such a manner that the transmission/reception unit 112 constitutes a network together with plural input/output units 211 with predetermined short-range wireless communication methods such as wireless LAN, Bluetooth, and UWB so as to perform communications.

The input/output units 211 are composed, for example, of devices having different functions, such as a monitor, a headphone, and an earphone, and the transmission/reception unit 112 transmits the signal from the tuner unit 111 to the monitor, the headphone, or the earphone. The monitor extracts a video signal from the signal supplied from the transmission/reception unit 112 and displays it on a screen. Moreover, the headphone and the earphone extract an audio signal from the signal supplied from the transmission/reception unit 112 and output it as an audio signal (sound).

As shown in FIG. 9, the input/output units 211 may be composed, for example, of monitor devices having the same configuration and be structured such that plural users share the information supplied from the tuner unit 111.

Note that at this time the transmission/reception unit 112 measures the position of the input/output units 211 and the distance between the transmission/reception unit 112 and the input/output units 211 with the position and distance measuring function of UWB wireless communication. As a result, the transmission/reception unit 112 forms a UWB wireless communication network together with the input/output units 211, which are determined to be present in a predetermined distance or closer. The position and distance measuring function of the UWB wireless communication generates an impulse including a command for requesting the ID of each device from the transmission/reception unit 112, measures the time required for reporting the ID from each device, and determines the position and the distance in accordance with the measured time.

As described above, the transmission/reception unit 112 communicates with the input/output units 211 present in a specific distance and area to provide information inherent in each area from the tuner unit 111 using the position and distance measuring function of the UWB wireless communication. With this configuration, it is possible that information on specific areas such as a park and a zoo will be received by the tuner unit 111 and then transmitted to the input/output units 211 present in the specific area via the transmission/reception unit 112. Accordingly, the information can be viewed and listened to at the input/output unit 211.

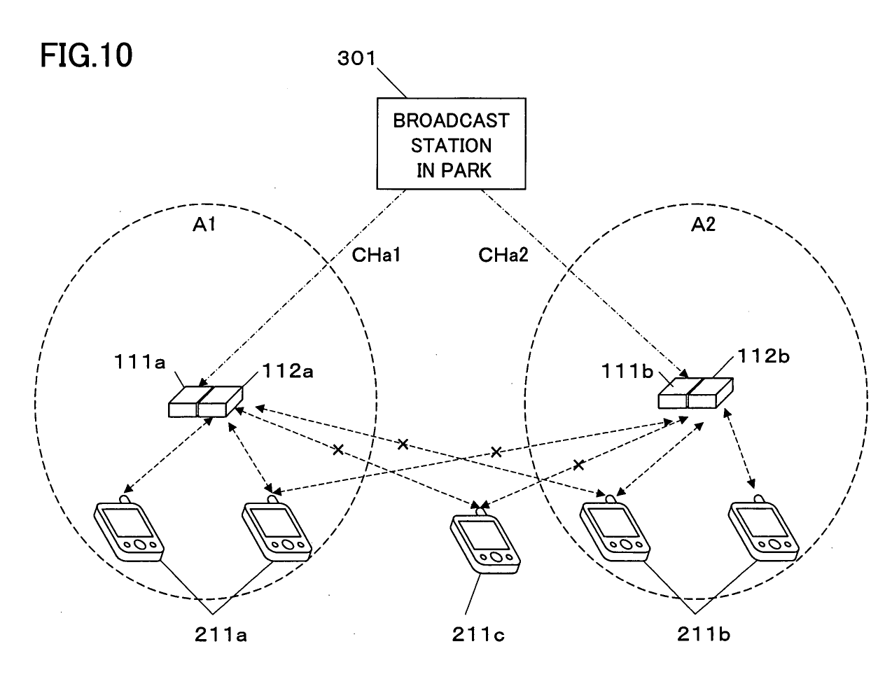

FIG. 10 shows an operational explanatory view of an example to which the embodiments of the present invention are applied. In FIG. 10, reference numeral 301 denotes, for example, a broadcast station in a park. The broadcast station 301 broadcasts information on specific area A1 through the channel CHa1 and information on specific area A2 through the channel CHa2.

A tuner unit 111a and a transmission/reception unit 112a are arranged in the specific area A1. The tuner unit 111a receives the broadcast of the channel CHa1 transmitted from the broadcast station 301. The transmission/reception unit 112a wirelessly transmits the broadcast signal from the tuner unit 111a to the input/output units 211a, which are determined to be present in the specific area A1 by the position and distance measuring function of UWB wireless communication. The input/output units 211a receive the broadcast signal regarding the specific area A1 from the transmission/reception unit 112a and display it on a monitor while outputting the same from a speaker as audio.

A tuner unit 111b and a transmission/reception unit 112b are arranged in the specific area A2. The tuner unit 111b receives the broadcast of the channel CHa2 transmitted from the broadcast station 301. The transmission/reception unit 112b wirelessly transmits the broadcast signal from the tuner unit 111b to the input/output units 211b, which are determined to be present in the specific area A2 by the position and distance measuring function of the UWB wireless communication. The input/output units 211b receive the broadcast signal regarding the specific area A2 from the transmission/reception unit 112b and display it on a monitor while outputting the same from a speaker as audio. At this time, the broadcast signals from the transmission/reception units 112a and 112b are not transmitted to an input/output unit 211c that is not present in either the specific area A1 or the specific area A2.

Accordingly, the user is allowed to view the information corresponding to moving locations while moving around a park with the input/output units 211.

According to the embodiments of the present invention, the driving power source is incorporated in each device, thereby making it possible to lengthen the service life of batteries constituting the power source.

Furthermore, the embodiments exemplify the tuner unit 111 as the first device. However, the first device is not limited to the tuner unit 111. Alternatively, it could be a device capable of transmitting a signal from the relay device to the second device and providing information to the second device located in a specific area using the distance measuring function of the UWB wireless communication. The first device may, for example, be in the form of relays such as LAN and WAN or mobile-phone handsets.

The present invention is not limited to the specifically disclosed embodiment, and variations and modifications may be made without departing from the scope of the present invention.

The present application is based on Japanese Priority Application No. 2007-246035 filed on Sep. 21, 2007, with Japan Patent Office, the entire contents of which are hereby incorporated by reference.

What is claimed is:

1. A communication system comprising:
a first device that performs communication of information with an outside;
a second device through which the information is input and output; and
a relay device that performs wired communication with the first device and wireless communication with the second device to relay the information between the first device and the second device.

2. The communication system according to claim 1, wherein
the first device receives a broadcast, and the relay device performs short-range wireless communication with the second device to transmit the broadcast received by the first device to the second device.

3. The communication system according to claim 1, wherein
the first device includes a broadcast reception section that receives a broadcast, a processing section that processes a signal received by the broadcast reception section, and a first interface section that transmits the signal processed by the processing section to the relay device.

4. The communication system according to claim 1, wherein
the relay device is capable of constituting a wireless communication network.

5. The communication system according to claim 1, wherein
the first device and the relay device are directly connected to each other through a connector.

6. The communication system according to claim 1, wherein
at least the relay device and the second device perform wireless communication through ultra-wide band wireless communication.

7. The communication system according to claim 1, wherein
at least the relay device and the second device have an ultra-wide band antenna.

8. The communication system according to claim 6, wherein
at least the relay device and the second device measure a position and a distance with a position and distance measuring function of the ultra-wide band wireless communication and form a network based on a result of measuring the position and the distance.

9. The communication system according to claim 1, wherein
the first device receives information transmitted from a device present in a specific area and transmits the information to the second device via the relay device.

10. A communication method comprising the steps of:
performing communication of information with an outside using a first device; and
performing communication of the information wirelessly between a relay device connected to the first device and a second device through which the information is input and output.
